(19) United States
(12) Patent Application Publication
(10) Pub. No.: US 2024/0378130 A1
(43) Pub. Date: Nov. 14, 2024

(54) PERFORMANCE DEGRADATION-BASED PRODUCT RELIABILITY WEAK LINK EVALUATION METHOD AND APPARATUS

(71) Applicant: CHINA ELECTRONIC PRODUCT RELIABILITY AND ENVIRONMENTAL TESTING RESEARCH INSTITUTE((THE FIFTH, Guangzhou (CN)

(72) Inventors: Guangze PAN, Guangzhou (CN); Dan Li, Guangzhou (CN); Bochen Chen, Guangzhou (CN); Lijun Sun, Guangzhou (CN); Qian Li, Guangzhou (CN); Yuanhang Wang, Guangzhou (CN); Wenwei Liu, Guangzhou (CN); Jianfeng Yang, Guangzhou (CN); Xiaojian Ding, Guangzhou (CN)

(21) Appl. No.: 18/601,462

(22) Filed: Mar. 11, 2024

(30) Foreign Application Priority Data
May 9, 2023 (CN) 202310512578.4

(51) Int. Cl. G06F 11/34

(52) U.S. Cl. CPC G06F 11/3447; G06F 11/3452

(57) ABSTRACT

A performance degradation-based product reliability weak link evaluation method includes: acquiring a performance degradation parameter of each component of a to-be-evaluated product corresponding to each test time point; evaluating the performance degradation parameter of each component corresponding to each test time point through a fault time evaluation model, to obtain a pre-fault operating duration of each component; evaluating the pre-fault operating duration of each component through a confidence-based unreliability evaluation method, to obtain an unreliability evaluation result of each component; generating at least one component service life distribution model corresponding to each component according to the unreliability evaluation result, and selecting a corresponding target component service life distribution model; and evaluating mean time between failures corresponding to each component according to the target component service life distribution model, and selecting a reliability weak link of the to-be-evaluated product according to the mean time between failures corresponding to each component.

### CROSS REFERENCE TO RELATED APPLICATION

The present application claims priority to Chinese Patent Application with No. 202310512578.4, entitled “Performance Degradation-Based Product Reliability Weak Link Evaluation Method and Apparatus”, and filed on May 9, 2023, the content of which is expressly incorporated herein by reference in its entirety.

### TECHNICAL FIELD

The present disclosure relates to the field of product reliability evaluation technology, and particularly to a performance degradation-based product reliability weak link evaluation method and apparauts, a computer device, a storage medium, and a computer program product.

### BACKGROUND

With the rapid development of science and technology and increasingly intense market competition, a composition structure of a product is becoming more and more complex, and function performances of the product are becoming more and more complex and intelligent. Consequently, quality and reliability requirements for the product by a user is becoming higher and higher. Currently, there is no effective reliability weak link evaluation method for a high-reliability and long-life complex product, accordingly the requirement for rapid improvement of the product quality and reliability is not satisfied. Therefore, it is urgent to carry out research on the reliability weak link evaluation method for a product, and to improve the design by rapidly determining the weak link in product quality and reliability, in order to rapidly improve the product quality and reliability.

Currently, in most of the conventional reliability weak link evaluation method, a product fault data statistics method is applied, that is, the fault data of each component of the product is analyzed, and all pre-fault working hours of the components are counted by dividing the total quantity of the components as the average life of each component, and the reliability weak link of the product is determined according to the average life of each component. This method is applicable only to the case where all components are faulty. If some components are not faulty, the statistical result differs greatly from the actual condition of the components, and the reliability evaluation result is inaccurate, which may result in inaccurate reliability weak link.

### SUMMARY

In view of the above, as for the above technical problem, it is necessary to provide a performance degradation-based product reliability weak link evaluation method and apparatus, a computer device, a computer-readable storage medium, and a computer program product that can improve the evaluation accuracy of the reliability weak link of the product.

In the first aspect of the present disclosure, a reliability weak link evaluation method for a product with a performance degradation is provided, including: acquiring a performance degradation parameter of each component of a to-be-evaluated product corresponding to each test time point; evaluating the performance degradation parameter of each component corresponding to each test time point through a fault time evaluation model, to obtain a pre-fault operating duration of each component; evaluating the pre-fault operating duration of each component through a confidence-based unreliability evaluation method, to obtain an unreliability evaluation result of each component; generating at least one component service life distribution model corresponding to each component according to the unreliability evaluation result of each component, and selecting a corresponding target component service life distribution model; and evaluating mean time between failures corresponding to each component according to the target component service life distribution model of each component, and selecting a reliability weak link of the to-be-evaluated product according to the mean time between failures corresponding to each component.

In an embodiment, the test time points are equally spaced, the evaluating the performance degradation parameter of each component corresponding to each test time point through the fault time evaluation model to obtain the pre-fault operating duration of each component includes: inputting the performance degradation parameter of each component corresponding to each test time point into a first transformation unit of the fault time evaluation model, to obtain a performance degradation transformation parameter corresponding to each test time point; inputting the performance degradation transformation parameter corresponding to each test time point into a second transformation unit of the fault time evaluation model, to obtain a degradation transformation average parameter corresponding to test time points; inputting the performance degradation parameter and the degradation transformation average parameter into an intermediate parameter determination unit of the fault time evaluation model, to obtain a target intermediate parameter; and inputting the target intermediate parameter into a fault time output unit of the fault time evaluation model to obtain the pre-fault operating duration corresponding to each component.

In an embodiment, the inputting the performance degradation parameter of each component corresponding to each test time point into the first transformation unit of the fault time evaluation model to obtain the performance degradation transformation parameter corresponding to each test time point includes: determining, through the first transformation unit, a sum of a performance degradation parameter corresponding to a test time point and a performance degradation parameter corresponding to each test time point before the test time point as the performance degradation transformation parameter corresponding to the test time point.

In an embodiment, the inputting the performance degradation transformation parameter corresponding to each test time point into the second transformation unit of the fault time evaluation model to obtain the degradation transformation average parameter corresponding to test time points includes: for the performance degradation transformation parameter corresponding to each test time point, determining an average value of performance degradation transformation parameters corresponding to every two adjacent test time points through the second transformation unit; and obtaining the degradation transformation average parameter according to the average value of the performance degradation transformation parameters corresponding to every two adjacent test time points.

In an embodiment, there exists a plurality of same components, a pre-fault operating duration corresponding to the plurality of same components includes a pre-fault operating duration corresponding to each of the same components, the unreliability evaluation result comprises an unreliability corresponding to each pre-fault operating duration; the generating at least one component service life distribution model corresponding to each component according to the unreliability evaluation result of each component includes: performing fitting on each preset cumulative fault probability function based on the pre-fault operating duration corresponding to each component and the unreliability corresponding to each pre-fault operating duration, to determine a parameter value corresponding to an unknown parameter in each cumulative fault probability function; and generating at least one component service life distribution model corresponding to each component according to the parameter value corresponding to the unknown parameter in each cumulative fault probability function.

In an embodiment, the performing the fitting on each preset cumulative fault probability function based on the pre-fault operating duration corresponding to each component and the unreliability corresponding to each pre-fault operating duration to determine the parameter value corresponding to the unknown parameter in each cumulative fault probability function includes: determining a decision function corresponding to each cumulative fault probability function, wherein the decision function is built according to a derivative of each cumulative fault probability function, and a function value of each cumulative fault probability function matches the unreliability corresponding to each pre-fault operating duration; and determining the parameter value corresponding to the unknown parameter in each cumulative fault probability function according to the derivative of the corresponding decision function with respect to the unknown parameter in each cumulative fault probability function.

In an embodiment, the selecting the corresponding target component service life distribution model includes: determining a function value of the decision function corresponding to each cumulative fault probability function according to the parameter value corresponding to the unknown parameter in each cumulative fault probability function; and determining a cumulative fault probability function corresponding to the maximum value of the decision function as a target cumulative fault probability function; and determining a model represented by the target cumulative fault probability function as the target component service life distribution model.

In the second aspect of the present disclosure, a performance degradation-based product reliability weak link evaluation apparatus is provided, including: a parameter acquisition module, configured to acquire a performance degradation parameter of each component of a to-be-evaluated product corresponding to each test time point; a first evaluation module, configured to evaluate the performance degradation parameter of each component corresponding to each test time point through a fault time evaluation model, to obtain a pre-fault operating duration of each component; a second evaluation module, configured to evaluate the pre-fault operating duration of each component through a confidence-based unreliability evaluation method, to obtain an unreliability evaluation result of each component; a generation module, configured to generate at least one component service life distribution model corresponding to each component according to the unreliability evaluation result of each component, and select a corresponding target component service life distribution model; and a selection module, configured to evaluate mean time between failures corresponding to each component according to the target component service life distribution model of each component, and select a reliability weak link of the to-be-evaluated product according to the mean time between failures corresponding to each component.

In the third aspect of the present disclosure, a computer device is provided, including a processor and a memory storing a computer program, the processor, when executing the computer program, implements the step of: acquiring a performance degradation parameter of each component of a to-be-evaluated product corresponding to each test time point; evaluating the performance degradation parameter of each component corresponding to each test time point through a fault time evaluation model, to obtain a pre-fault operating duration of each component; evaluating the pre-fault operating duration of each component through a confidence-based unreliability evaluation method, to obtain an unreliability evaluation result of each component; generating at least one component service life distribution model corresponding to each component according to the unreliability evaluation result of each component, and selecting a corresponding target component service life distribution model; and evaluating mean time between failures corresponding to each component according to the target component service life distribution model of each component, and selecting a reliability weak link of the to-be-evaluated product according to the mean time between failures corresponding to each component.

In the fourth aspect of the present disclosure, a computer readable storage medium is provided, on which a computer program is stored, the computer program, when executed by a processor, causes the processor to implement the steps of: acquiring a performance degradation parameter of each component of a to-be-evaluated product corresponding to each test time point; evaluating the performance degradation parameter of each component corresponding to each test time point through a fault time evaluation model, to obtain a pre-fault operating duration of each component; evaluating the pre-fault operating duration of each component through a confidence-based unreliability evaluation method, to obtain an unreliability evaluation result of each component; generating at least one component service life distribution model corresponding to each component according to the unreliability evaluation result of each component, and selecting a corresponding target component service life distribution model; and evaluating mean time between failures corresponding to each component according to the target component service life distribution model of each component, and selecting a reliability weak link of the to-be-evaluated product according to the mean time between failures corresponding to each component.

In the fifth aspect of the present disclosure, a computer program product is provided, including a computer program, the computer program, when executed by a processor, causes the processor to implement the steps of: acquiring a performance degradation parameter of each component of a to-be-evaluated product corresponding to each test time point; evaluating the performance degradation parameter of each component corresponding to each test time point through a fault time evaluation model, to obtain a pre-fault operating duration of each component; evaluating the pre-fault operating duration of each component through a confidence-based unreliability evaluation method, to obtain an unreliability evaluation result of each component; generating at least one component service life distribution model corresponding to each component according to the unreliability evaluation result of each component, and selecting a corresponding target component service life distribution model; and evaluating mean time between failures corresponding to each component according to the target component service life distribution model of each component, and selecting a reliability weak link of the to-be-evaluated product according to the mean time between failures corresponding to each component.

With the above-mentioned reliability weak link evaluation method and apparatus, the computer device, the computer-readable storage medium, and the computer program product, a performance degradation parameter of each component of a to-be-evaluated product corresponding to each test time point is acquired, the performance degradation parameter of each component corresponding to each test time point is evaluated through a fault time evaluation model to obtain a pre-fault operating duration of each component, the pre-fault operating duration of each component is evaluated through a confidence-based unreliability evaluation method to obtain an unreliability evaluation result of each component, at least one component service life distribution model corresponding to each component is generated according to the unreliability evaluation result of each component, and a corresponding target component service life distribution model is selected; mean time between failures corresponding to each component is evaluated according to the target component service life distribution model of each component, and a reliability weak link of the to-be-evaluated product is selected according to the mean time between failures corresponding to each component.

In such a manner, the performance degradation parameter analysis method is adopted to effectively evaluate the performance degradation data of the component, and obtain the pre-fault operating duration of the component. The method can be adapted to both the product with performance degradation data and the product with fault data, i.e., can be applied to a wider range, in order to satisfy the requirement for rapid evaluation of the reliability weak link of the long-life complex product. Further, the component is evaluated by using the confidence-based unreliability evaluation method, which can evaluate the unreliability at any confidence level, and may also be applied to a wider range. Therefore, the reliability weak link of the complex product can be evaluated through the selected target component service life distribution model, thereby effectively improving the evaluation precision.

### BRIEF DESCRIPTION OF THE DRAWINGS

FIG. 1 is a flow chart showing a performance degradation-based product reliability weak link evaluation method according to an embodiment.

FIG. 2 is a flow chart showing steps of evaluating a performance degradation parameter corresponding to each test time point according to an embodiment.

FIG. 3 is a flow chart showing a reliability weak link evaluation method for a product with a performance degradation according to another embodiment.

FIG. 4 is a schematic structure diagram illustrating a performance degradation-based product reliability weak link evaluation apparatus according to an embodiment.

FIG. 5 is an internal structure diagram of a computer device according to an embodiment.

### DETAILED DESCRIPTION

In order to make the purpose, technical solution, and advantages of the present disclosure clearer, the present disclosure will be elaborated below with reference to the accompanying drawings and embodiments. It should be appreciated that the specific embodiments described herein are merely illustrative of the present disclosure and are not intended to limit the present disclosure.

It should be noted that the terms “first” and “second” in the specification, claims, and accompanying drawings of the present disclosure are used for distinguishing between similar objects, and do not need to be used for describing a specific sequence or order. It should be appreciated that the data thus used may be interchangeable, as appropriate, so that the embodiments of the present disclosure described herein can be implemented in a sequence other than those shown or described herein. The implementation modes described in the following exemplary embodiments do not represent all implementation modes consistent with the present disclosure. Rather, these implementation modes are merely examples of the apparatus and method consistent with some aspects of the present disclosure as detailed in the appended claims.

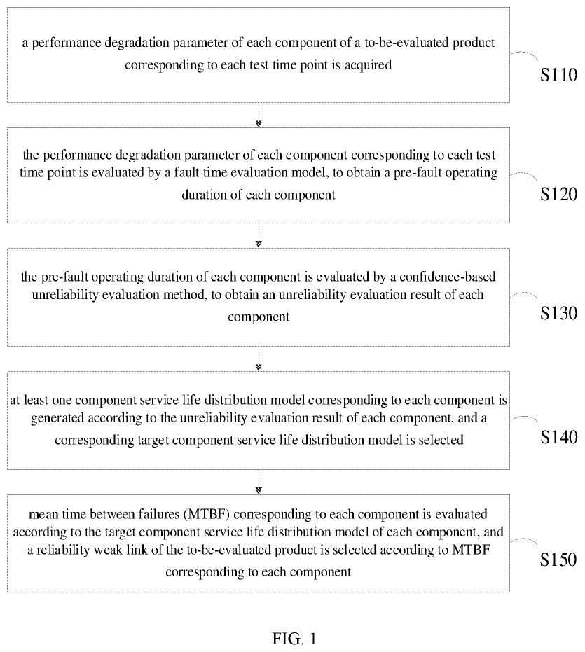

In an embodiment, as shown in FIG. 1, a performance degradation-based product reliability weak link evaluation method is provided. It should be appreciated that the method may be applied to a terminal, or may be applied to a server, or may be applied to a system including a terminal and a server, and is implemented by means of interaction between the terminal and the server. The server may be an independent server or a server cluster including multiple servers. This embodiment is described as an example by applying the method to a server. The method may include the following steps S110 to S150.

Step S110: a performance degradation parameter of each component of a to-be-evaluated product corresponding to each test time point is acquired.

The component may be a part of the to-be-evaluated product.

Specifically, performance tests may be performed on each component of the to-be-evaluated product at different test time points, to obtain performance degradation parameters of each component of the to-be-evaluated product corresponding to respective test time points, so that the server may obtain the performance degradation parameters of each component of the to-be-evaluated product corresponding to respective test time points.

Step S120: the performance degradation parameter of each component corresponding to each test time point is evaluated by a fault time evaluation model, to obtain a pre-fault operating duration of each component.

The pre-fault operating duration refers to a duration in which the component operates normally before a fault occurs. In an actual application, the pre-fault operating duration of the component may be referred to as a service life of the component.

The component may be a part of the to-be-evaluated product.

Specifically, for a component of the to-be-evaluated product, the server may evaluate a performance degradation parameter of the component corresponding to each test time point by using the fault time evaluation model, to obtain the pre-fault operating duration t of the component.

In such a manner, the server may determine a pre-fault operating duration corresponding to each component in the to-be-evaluated product by the same method.

Step S130: the pre-fault operating duration of each component is evaluated by a confidence-based unreliability evaluation method, to obtain an unreliability evaluation result of each component.

The pre-fault operating duration of each component may include the pre-fault operating duration of each component in the same batch.

Specifically, the server may obtain a performance degradation parameter of a component in the to-be-evaluated product corresponding to each test time point, and estimate a pre-fault operating duration of the component according to the performance degradation parameter of the component corresponding to each test time point, and then evaluate the pre-fault operating duration of the same components in the same batch based on the same method.

The unreliability evaluation result may include an unreliability corresponding to the pre-fault operating duration.

In specific implementation, the server may evaluate a component by the confidence-based unreliability evaluation method, to obtain an unreliability of the component. An evaluation formula is as follows:

$$α = {\sum }_{j = i}^{n} {{C}_{n}^{j} [ 1 - F ]}^{j} {F}^{n - j} .$$

In the above formula, F denotes an unreliability, a denotes a confidence which can be specified as required, n denotes a total number of the same components in the same batch, i denotes a sequence number of a component sorted from small to large according to the pre-fault operating duration, and j denotes a sequence number satisfying i≤j≤n.

Accordingly, an unreliability evaluation result of a component is shown in the following Table 1, F(tᵢ) denotes an unreliability corresponding to the moment tᵢ, where tᵢ denotes the pre-fault operating duration.

TABLE 1
Unreliability evaluation results of components

| Serial | pre-fault operating | Unreliability solution | Unreliability |
|---|---|---|---|
| number | duration after sorting | formula | F(tᵢ) |
| 1 | t₁ | $α = \text{?} C {\text{?}}_{a} [ 1 - F ( {t}_{1} ) ] {\text{?} [ F ( {t}_{1} ) ]}^{n -} \text{?}$ | F(t₁) |
| 2 | t2 | $α = \text{?} C {\text{?}}_{a} [ 1 - F ( {t}_{2} ) ] {\text{?} [ F ( {t}_{2} ) ]}^{n -} \text{?}$ | F(t₂) |
| 3 | t3 | $α = \text{?} C {\text{?}}_{a} [ 1 - F ( {t}_{3} ) ] {\text{?} [ F ( {t}_{3} ) ]}^{n -} \text{?}$ | F(t₃) |
| 4 | t4 | $α = \text{?} C {\text{?}}_{a} [ 1 - F ( {t}_{4} ) ] {\text{?} [ F ( {t}_{4} ) ]}^{n -} \text{?}$ | F(t₄) |
| 5 | t5 | $α = \text{?} C {\text{?}}_{a} [ 1 - F ( {t}_{5} ) ] {\text{?} [ F ( {t}_{5} ) ]}^{n -} \text{?}$ | F(t₅) |
| . . . | . . . | . . . | . . . |
| n | tₙ | $α = \text{?} C {\text{?}}_{a} [ 1 - F ( {t}_{n} ) ] {\text{?} [ F ( {t}_{n} ) ]}^{n -} \text{?}$ | F(tₙ) |

$\text{?} \text{indicates text missing or illegible when filed}$

In such a manner, the component is evaluated by the confidence-based unreliability evaluation method, which can evaluate the unreliability at any confidence level, and accordingly can be applied in a wider range.

Step S140: at least one component service life distribution model corresponding to each component is generated according to the unreliability evaluation result of each component, and a corresponding target component service life distribution model is selected.

Specifically, the server may perform a fitting operation on a preset cumulative fault probability function including an unknown parameter according to an unreliability evaluation result of any one component. Different component service life distribution models are obtained for different cumulative fault probability functions, and serve as at least one component service life distribution model of the one component. In such a manner, the server may select an optimal component service life distribution model from at least one component service life distribution model as the target component service life distribution model.

Step S150: mean time between failures (MTBF) corresponding to each component is evaluated according to the target component service life distribution model of each component, and a reliability weak link of the to-be-evaluated product is selected according to MTBF corresponding to each component.

Specifically, the server may evaluate mean time between failures (MTBF) corresponding to a component according to the target component service life distribution model of the component, and select the reliability weak link of the to-be-evaluated product according to the MTBF corresponding to each component in the to-be-evaluated product.

Specifically, the mean time between failures T corresponding to the component is evaluated according to the target component service life distribution model of the component. The formula for evaluating the mean time between failures may be as follows:

$$T = {\int }_{0}^{∞} \{ t \times {[ F ( t ) ]}^{′} \} dt ;$$

where F(t) is an expression of the target component service life distribution model.

With the same method, the server may determine the mean time between failures corresponding to each component based on the target component service life distribution model corresponding to each component of the to-be-evaluated product. Consequently, the server may determine a component of the to-be-evaluated product with the mean time between failures less than a preset time threshold as a reliability weak link of the to-be-evaluated product.

Further, the server may further arrange the mean time between failures in an ascending order, and obtain components with the mean time between failures in previous preset positions as reliability weak links of the to-be-evaluated product, in which a ratio of the number of the components to a total number of components consisting the product is not greater than a preset proportion (for example, may be 40%, and a specific proportion is not limited herein).

In the above-mentioned performance degradation-based product reliability weak link evaluation method, the performance degradation parameter of each component of the to-be-evaluated product corresponding to each test time point is acquired; the performance degradation parameter of the component corresponding to each test time point is evaluated by the fault time evaluation model, to obtain a pre-fault operating duration corresponding to the component; the pre-fault operating duration corresponding to the component is evaluated by the confidence-based unreliability evaluation method, to obtain the unreliability evaluation result corresponding to the component; at least one component service life distribution model corresponding to the component is generated according to the unreliability evaluation result corresponding to the component, and a corresponding target component service life distribution model is selected; the mean time between failures corresponding to the component is evaluated according to the target component service life distribution model corresponding to the component, and the reliability weak link of the to-be-evaluated product is selected according to the mean time between failures corresponding to the component.

In such a manner, the performance degradation parameter analysis method is adopted to effectively evaluate the performance degradation data of the component, and obtain the pre-fault operating duration of the component. The method can be adapted to both the product with performance degradation data and the product with fault data, i.e., can be applied to a wider range, in order to satisfy the requirement for rapid evaluation of the reliability weak link of the long-life complex product. Further, the component is evaluated by using the confidence-based unreliability evaluation method, which can evaluate the unreliability at any confidence level, and may also be applied to a wider range. Therefore, the reliability weak link of the complex product can be evaluated through the selected target component service life distribution model, thereby effectively improving the evaluation precision.

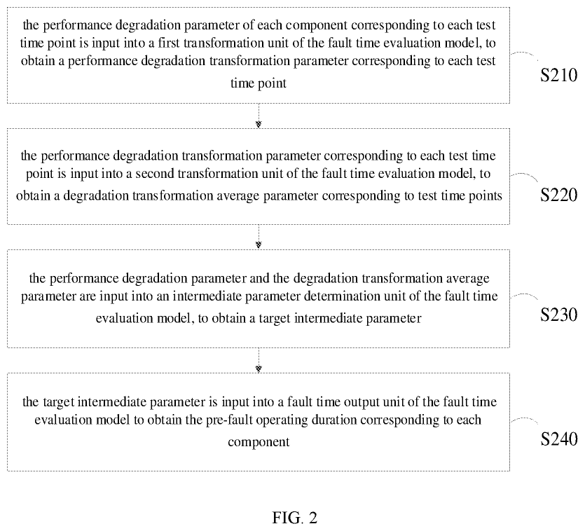

In an embodiment, as shown in FIG. 2, the step S120 may further include the following steps S210 to S240.

Step S210: the performance degradation parameter of each component corresponding to each test time point is input into a first transformation unit of the fault time evaluation model, to obtain a performance degradation transformation parameter corresponding to each test time point.

Each test time point is equally spaced.

Specifically, the server may input the performance degradation parameter of a component corresponding to each test time point into the first transformation unit of the fault time evaluation model, to obtain the performance degradation transformation parameter corresponding to each test time point.

Step S220: the performance degradation transformation parameter corresponding to each test time point is input into a second transformation unit of the fault time evaluation model, to obtain a degradation transformation average parameter corresponding to test time points.

Specifically, the server may input the performance degradation transformation parameter corresponding to each test time point into the second transformation unit of the fault time evaluation model, to obtain the degradation transformation average parameter corresponding to the test time points.

Step S230: the performance degradation parameter and the degradation transformation average parameter are input into an intermediate parameter determination unit of the fault time evaluation model, to obtain a target intermediate parameter.

Specifically, the server may input the performance degradation parameter and the degradation transformation average parameter into the intermediate parameter determination unit of the fault time evaluation model to obtain the target intermediate parameter.

Step S240: the target intermediate parameter is input into a fault time output unit of the fault time evaluation model to obtain the pre-fault operating duration corresponding to each component.

Specifically, the server may input the target intermediate parameter into the fault time output unit of the fault time evaluation model, to obtain the pre-fault operating duration corresponding to the component.

Based on the same method, the server may determine the pre-fault operating duration corresponding to the same components in the same batch.

In the technical solution of the embodiment, each test time point is equally spaced, the performance degradation parameter corresponding to each test time point is input into the first transformation unit of the fault time evaluation model to obtain the performance degradation transformation parameter corresponding to each test time point, the performance degradation transformation parameter corresponding to each test time point is input into the second transformation unit of the fault time evaluation model to obtain the degradation transformation average parameter corresponding to the test time points, the performance degradation parameter and the degradation transformation average parameter are input into the intermediate parameter determination unit of the fault time evaluation model to obtain the target intermediate parameter, the target intermediate parameter is input into the fault time output unit of the fault time evaluation model to obtain the pre-fault operating duration corresponding to the component. In such a manner, by using the performance degradation parameter analysis method, the performance degradation data of the component can be effectively evaluated, and the pre-fault operating duration of the component can be obtained, which can be adapted to both the product with the performance degradation data and the product with the fault data, and thus can be applied to a wider range, so that the requirement for rapid evaluation of the reliability weak link of the long-life complex product can be satisfied.

In an embodiment, the step of inputting the performance degradation parameter of the component corresponding to each test time point into the first transformation unit of the fault time evaluation model to obtain the performance degradation transformation parameter corresponding to each test time point may include: a sum of a performance degradation parameter corresponding to a test time point and a performance degradation parameter corresponding to each test time point before the test time point is determined by the first transformation unit as the performance degradation transformation parameter corresponding to the test time point.

Specifically, in the process in which the server inputs the performance degradation parameter corresponding to each test time point into the first transformation unit of the fault time evaluation model to obtain the performance degradation transformation parameter corresponding to each test time point, the first transformation unit may determine, for any test time point, a sum of the performance degradation parameter corresponding to the test time point and the performance degradation parameter corresponding to each test time point before the test time point, and determine the sum as the performance degradation transformation parameter corresponding to the test time point. In such a manner, the performance degradation transformation parameter corresponding to each test time point may be obtained based on the same method.

Specifically, it is assumed that a component is tested at an equal time interval, and the performance degradation parameters of the component at each test time point are respectively represented as y₁₁, y₁₂, y₁ₘ, . . . , y_{1d}, where d denotes the number of tests (there exists a one-to-one correspondence between each test and a test time point), and m=1,2, . . . , d. The first transformation unit transforms the performance degradation parameter as follows,

$$\{ \begin{matrix}{y}_{21} = {y}_{11} \\ {y}_{22} = {y}_{11} + {y}_{12} \\ {y}_{23} = {y}_{11} + {y}_{12} + {y}_{13} \\ … \\ {y}_{2 m} = {y}_{11} + {y}_{12} + {y}_{13} + … + {y}_{1 m} \\ … \\ {y}_{2 d} = {y}_{11} + {y}_{12} + … + {y}_{1 m} + … + {y}_{1 d}\end{matrix} ,$$

to obtain the performance degradation transformation parameter corresponding to each test time point: y₂₁, y₂₂, y₂ₘ, . . . , y_{2d}.

In such a manner, through the above formulas, the performance degradation parameter of the component corresponding to each test time point may be transformed, to determine the performance degradation transformation parameter of the component corresponding to each test time point.

The step of inputting the performance degradation transformation parameter corresponding to each test time point into the second transformation unit of the fault time evaluation model to obtain the degradation transformation average parameter corresponding to the test time points may include: for the performance degradation transformation parameter corresponding to each test time point, an average value of performance degradation transformation parameters corresponding to every two adjacent test time points is determined by the second transformation unit, and the degradation transformation average parameter is obtained according to the average value of the performance degradation transformation parameters corresponding to every two adjacent test time points.

Specifically, the second transformation unit performs the transformation on y₂₁, y₂₂, y₂ₘ, . . . , y_{2d} as follows,

$$\{ \begin{matrix}{y}_{32} = ( {y}_{21} + {y}_{22} ) / 2 \\ {y}_{33} = ( {y}_{22} + {y}_{23} ) / 2 \\ {y}_{34} = ( {y}_{23} + {y}_{24} ) / 2 \\ … \\ {y}_{3 m} = ( {y}_{2 m - 1} + {y}_{2 m} ) / 2 \\ … \\ {y}_{3 d} = ( {y}_{2 d - 1} + {y}_{2 d} ) / 2\end{matrix} ,$$

to obtain the degradation transformation average parameter corresponding to the test time points: y₃₂, y₃₃, y₃ₘ, . . . , y_{3d}.

In such a manner, by the above-mentioned formulas, the degradation transformation average parameter can be obtained by performing the transformation on the performance degradation transformation parameter corresponding to each test time point.

In the process of inputting the performance degradation parameter and the degradation transformation average parameter into the intermediate parameter determination unit of the fault time evaluation model to obtain the target intermediate parameter, the intermediate parameter determination unit solves parameter values of the unknown target intermediate parameters e and f through the following formula:

$$( \begin{matrix}e \\ f\end{matrix} ) = {( \begin{matrix}{y}_{32}^{2} + {y}_{33}^{2} + … + {y}_{3 d}^{2} & {y}_{32} + {y}_{33} + … + {y}_{3 d} \\ {y}_{32} + {y}_{33} + … + {y}_{3 d} & d - 1\end{matrix} )}^{- 1} \times ( \begin{matrix}{y}_{12} {y}_{32} + {y}_{13} {y}_{33} + … + {y}_{1 d} {y}_{3 d} \\ {y}_{12} + {y}_{13} + … + {y}_{1 d}\end{matrix} ) .$$

In the process of inputting the target intermediate parameter into the fault time output unit of the fault time evaluation model to obtain the pre-fault operating duration corresponding to the component, the fault time output unit outputs the pre-fault operating duration t through the following formula:

$$t = Δ t \times [ 1 - \frac{1}{e} ln ( \frac{eW - f}{{ey}_{11} - f} ) ] ;$$

where Δt denotes a time interval between test time points, and W denotes a performance degradation fault threshold corresponding to a component.

In such a manner, the pre-fault operating duration corresponding to the component can be evaluated through the above-mentioned formula.

In an embodiment, there may exist multiple same components. The pre-fault operating duration corresponding to a component may include pre-fault operating durations corresponding to the same components. The unreliability evaluation result may include an unreliability corresponding to each pre-fault operating duration. The step of generating the at least one component service life distribution model corresponding to the component according to the unreliability evaluation result corresponding to the component may include: a preset cumulative fault probability function is fitted based on the pre-fault operating duration corresponding to each component and the unreliability corresponding to each pre-fault operating duration, to determine a parameter value corresponding to an unknown parameter in each cumulative fault probability function; and at least one component service life distribution model corresponding to the component is generated according to the parameter value corresponding to the unknown parameter in each cumulative fault probability function.

Specifically, multiple same components are referred to as one component in the same batch.

The pre-fault operating duration corresponding to the component may include a pre-fault operating duration corresponding to each of the same components in the same batch.

The unreliability evaluation result may include the unreliability corresponding to each pre-fault operating duration.

Specifically, in the process of generating, by the server, the at least one component service life distribution model corresponding to the component according to the unreliability evaluation result corresponding to the component, the server may fit each preset cumulative fault probability function based on the pre-fault operating duration corresponding to each of the same components in the same batch and the unreliability corresponding to each pre-fault operating duration, to determine the parameter value corresponding to the unknown parameter in each cumulative fault probability function.

Each preset cumulative fault probability function F(t) is shown in the following Table 2, where a, b, and c are unknown parameters.

TABLE 2
Cumulative fault probability function of components

| Serial | Cumulative fault probability function |
|---|---|
| number | expressions |
| Cumulative fault probability | F(t) = 1 − exp(− at) |
| function 1 | |
| Cumulative fault probability | F(t) = 1 − exp[− a(t − b)] |
| function 2 | |
| Cumulative fault probability function 3 | $F ( t ) = 1 - exp [ - {( \frac{t}{a} )}^{b} ]$ |
| Cumulative fault probability function 4 | $F ( t ) = 1 - exp [ - {( \frac{t - c}{a} )}^{b} ]$ |
| Cumulative fault probability function 5 | $F ( t ) = {\int }_{0}^{t} \frac{1}{b \sqrt{2 π}} exp [ - \frac{1}{2} {( \frac{t - a}{b} )}^{2} ] dt$ |
| Cumulative fault probability function 6 | $F ( t ) = {\int }_{0}^{t} \frac{1}{bt \sqrt{2 π}} exp [ - \frac{1}{2} {( \frac{ln ( t ) - a}{b} )}^{2} ] dt$ |

In such a manner, after the parameter values corresponding to the unknown parameters in each cumulative fault probability function are determined, the parameter values of the unknown parameters are substituted into the corresponding cumulative fault probability function expression, so that at least one component service life distribution model corresponding to the component is generated. Based on the same method, the server may determine at least one component service life distribution model corresponding to each component of the to-be-evaluated product.

In the technical solution of the embodiment, each preset cumulative fault probability function is fitted based on the pre-fault operating duration corresponding to each component and the unreliability corresponding to each pre-fault operating duration, to determine the parameter value corresponding to the unknown parameter in each cumulative fault probability function; at least one component service life distribution model corresponding to each component is generated according to the parameter value corresponding to the unknown parameter in each cumulative fault probability function. In such a manner, the unreliability is fitted by using a plurality of cumulative fault probability functions that are more comprehensive and complete, thereby improving the precision of the component service life distribution model corresponding to the fitted component.

In an embodiment, the step of fitting each preset cumulative fault probability function based on the pre-fault operating duration corresponding to each component and the unreliability corresponding to each pre-fault operating duration to determine the parameter value corresponding to the unknown parameter in each cumulative fault probability function may include: a decision function corresponding to each cumulative fault probability function is determined; the decision function is built according to a derivative of each cumulative fault probability function; a function value of the cumulative fault probability function matches the unreliability corresponding to each pre-fault operating duration; the parameter value corresponding to the unknown parameter in each cumulative fault probability function is determined according to the derivative of the corresponding decision function with respect to the unknown parameter in each cumulative fault probability function.

Specifically, in the process that the server performs the fitting on each preset cumulative fault probability function based on the pre-fault operating duration corresponding to each component in the same batch and the unreliability corresponding to each pre-fault operating duration to determine the parameter value corresponding to the unknown parameter in each cumulative fault probability function, the server may determine the decision function corresponding to each cumulative fault probability function, the decision function is built according to the derivative of each cumulative fault probability function. In addition, the function value of each cumulative fault probability function matches the unreliability corresponding to the pre-fault operating duration.

Specifically, the decision function Q is defined as:

$$Q ( a , b , c ) = {\prod }_{i = 1}^{n} \{ {[ F ( t ) ]}^{′} ] t = {t}_{i} \} ;$$

where [F(t)]′|t=tᵢ is the value of the derivative of F(t) at tᵢ.

Then,

$$\{ \begin{matrix}\frac{dQ ( a , b , c )}{da} = 0 \\ \frac{dQ ( a , b , c )}{db} = 0 \\ \frac{dQ ( a , b , c )}{dc} = 0\end{matrix} ;$$

where

$$\frac{dQ ( a , b , c )}{da}$$

is the derivative of the function Q with respect to a. By solving the above equations, parameter values corresponding to the unknown parameters a, b, and c are obtained. In such a manner, the parameter value corresponding to the unknown parameter in each cumulative fault probability function can be determined according to the derivative of the decision function with respect to the unknown parameter in each cumulative fault probability function.

For example, the cumulative fault probability function 4 is taken as an example.

The decision function Q is defined as:

$$Q ( a , b , c ) = {\prod }_{i = 1}^{n} \{ \frac{b}{a} {( \frac{{t}_{i} - c}{a} )}^{b - 1} exp [ - {( \frac{{t}_{i} - c}{a} )}^{b} ] \} ,$$

then

$$\{ \begin{matrix}\frac{d \{ {\prod }_{i = 1}^{n} \{ \frac{b}{a} {( \frac{{t}_{i} - c}{a} )}^{b - 1} exp [ - {( \frac{{t}_{i} - c}{a} )}^{b} ] \} \}}{da} = 0 \\ \frac{d \{ {\prod }_{i = 1}^{n} \{ \frac{b}{a} {( \frac{{t}_{i} - c}{a} )}^{b - 1} exp [ - {( \frac{{t}_{i} - c}{a} )}^{b} ] \} \}}{db} = 0 \\ \frac{d \{ {\prod }_{i = 1}^{n} \{ \frac{b}{a} {( \frac{{t}_{i} - c}{a} )}^{b - 1} exp [ - {( \frac{{t}_{i} - c}{a} )}^{b} ] \} \}}{dc} = 0\end{matrix} .$$

By solving the above equations, parameter values corresponding to the unknown parameters a, b, and c in the cumulative fault probability function 4 is obtained.

In the technical solution of the embodiment, the decision function corresponding to each cumulative fault probability function is determined, the decision function is built according to the derivative of each cumulative fault probability function; the function value of each cumulative fault probability function matches the unreliability corresponding to the pre-fault operating duration; the parameter value corresponding to the unknown parameter in each cumulative fault probability function is determined according to the derivative of the corresponding decision function with respect to the unknown parameter in each cumulative fault probability function. In such a manner, the decision function corresponding to the cumulative fault probability function is built, the parameter value corresponding to the unknown parameter in the corresponding cumulative fault probability function is determined according to the derivative of the decision function with respect to the unknown parameter in the corresponding cumulative fault probability function. Therefore, the parameter value corresponding to the unknown parameter in each cumulative fault probability function can be determined, and the at least one component service life distribution model corresponding to the component can be more accurately built.

In an embodiment, the step of selecting the corresponding target component service life distribution model may include: a function value of the decision function corresponding to each cumulative fault probability function is determined according to the parameter value corresponding to the unknown parameter in each cumulative fault probability function; a cumulative fault probability function corresponding to the maximum value of the decision function serves as a target cumulative fault probability function; and a model represented by the target cumulative fault probability function serves as the target component service life distribution model.

Specifically, in the process of selecting, by the server, the corresponding target component service life distribution model in the at least one component service life distribution model corresponding to the component, the server may determine the function value of the decision function corresponding to each cumulative fault probability function according to the parameter value corresponding to the unknown parameter in each cumulative fault probability function corresponding to the component. Specifically, the function value of the decision function corresponding to each cumulative fault probability function is shown in the following Table 3.

TABLE 3
Function value of decision function corresponding to each cumulative fault
probability function

| Serial | Cumulative fault probability | Function value of |
|---|---|---|
| number | function expression | decision function |
| Cumulative fault probability function 1 | F(t) = 1 − exp(− at) | Q₁ |
| Cumulative fault probability function 2 | F(t) = 1 − exp[− a(t − b)] | Q₂ |
| Cumulative fault probability function 3 | $F ( t ) = 1 - exp [ - {( \frac{t}{a} )}^{b} ]$ | Q₃ |
| Cumulative fault probability function 4 | $F ( t ) = 1 - exp [ - {( \frac{t - c}{a} )}^{b} ]$ | Q₄ |
| Cumulative fault probability function 5 | $F ( t ) = {\int }_{0}^{t} \frac{1}{b \sqrt{2 π}} exp [ - \frac{1}{2} {( \frac{t - a}{b} )}^{2} ] dt$ | Q₅ |
| Cumulative fault probability function 6 | $F ( t ) = {\int }_{0}^{t} \frac{1}{bt \sqrt{2 π}} exp [ - \frac{1}{2} {( \frac{ln ( t ) - a}{b} )}^{2} ] dt$ | Q₆ |

Consequently, the server may determine the cumulative fault probability function corresponding to the maximum function value of decision function as the target cumulative fault probability function. The component service life distribution model represented by the target cumulative fault probability function serves as the target component service life distribution model corresponding to the component.

Specifically, when max(Q₁, Q₂, Q₃, Q₄, Q₅, Q₆)=Q₁, the cumulative fault probability function 1 serves as the target cumulative fault probability function.

When max(Q₁, Q₂, Q₃, Q₄, Q₅, Q₆)=Q₂, the cumulative fault probability function 2 serves as the target cumulative fault probability function.

When max(Q₁, Q₂, Q₃, Q₄, Q₅, Q₆)=Q₃, the cumulative fault probability function 3 serves as the target cumulative fault probability function.

When max(Q₁, Q₂, Q₃, Q₄, Q₅, Q₆)=Q₄, the cumulative fault probability function 4 serves as the target cumulative fault probability function.

When max(Q₁, Q₂, Q₃, Q₄, Q₅, Q₆)=Q₅, the cumulative fault probability function 5 serves as the target cumulative fault probability function.

When max(Q₁, Q₂, Q₃, Q₄, Q₅, Q₆)=Q₆, the cumulative fault probability function 6 serves as the target cumulative fault probability function.

In such a manner, the target component service life distribution model corresponding to each component forming the to-be-evaluated product can be determined based on the same method.

In the technical solution of the embodiment, the function value of the decision function corresponding to each cumulative fault probability function is determined according to the parameter value corresponding to the unknown parameter in each cumulative fault probability function; the cumulative fault probability function corresponding to the maximum function value of the decision function serves as the target cumulative fault probability function; the model represented by the target cumulative fault probability function serves as the target component service life distribution model. In such a manner, an optimum target cumulative fault probability function is selected from the plurality of cumulative fault probability functions according to the corresponding maximum function value of the decision function, to determine the target component service life distribution model corresponding to the component, so that a reliability weak link of the product can be more accurately evaluated according to the target component service life distribution model.

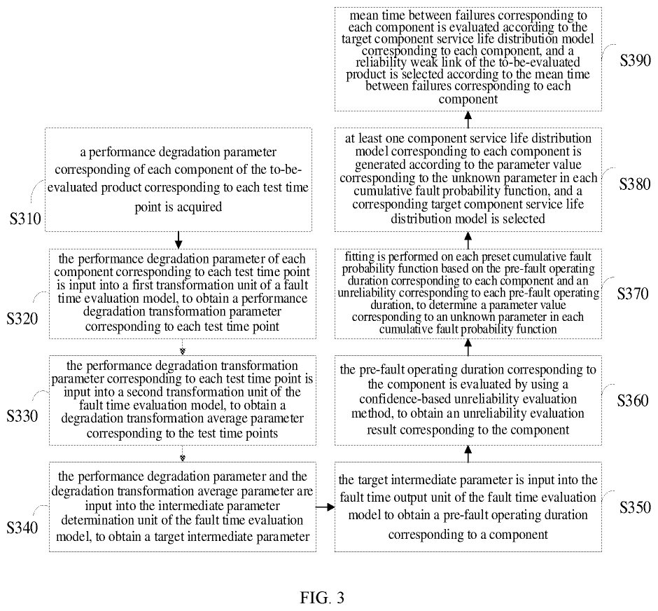

In another embodiment, as shown in FIG. 3, a performance degradation-based product reliability weak link evaluation method is provided. The method is applied to a server as an example for description, and the method may include the following steps S310 to S390.

Step S310: a performance degradation parameter corresponding to each component of the to-be-evaluated product corresponding to each test time point is acquired.

Step S320: the performance degradation parameter of each component corresponding to each test time point is input into a first transformation unit of a fault time evaluation model, to obtain a performance degradation transformation parameter corresponding to each test time point.

Step S330: the performance degradation transformation parameter corresponding to each test time point is input into a second transformation unit of the fault time evaluation model, to obtain a degradation transformation average parameter corresponding to the test time points.

Step S340: the performance degradation parameter and the degradation transformation average parameter are input into the intermediate parameter determination unit of the fault time evaluation model, to obtain a target intermediate parameter.

Step S350: the target intermediate parameter is input into the fault time output unit of the fault time evaluation model to obtain a pre-fault operating duration corresponding to a component.

Step S360: the pre-fault operating duration corresponding to the component is evaluated by using a confidence-based unreliability evaluation method, to obtain an unreliability evaluation result corresponding to the component.

Step S370: fitting is performed on each preset cumulative fault probability function based on the pre-fault operating duration corresponding to each component and an unreliability corresponding to each pre-fault operating duration, to determine a parameter value corresponding to an unknown parameter in each cumulative fault probability function.

Step 380: at least one component service life distribution model corresponding to each component is generated according to the parameter value corresponding to the unknown parameter in each cumulative fault probability function, and a corresponding target component service life distribution model is selected.

Step S390: mean time between failures corresponding to each component is evaluated according to the target component service life distribution model corresponding to each component, and a reliability weak link of the to-be-evaluated product is selected according to the mean time between failures corresponding to each component.

It should be noted that for specific limitations on the above-mentioned steps, reference can be made to the specific limitations on the aforementioned performance degradation-based product reliability weak link evaluation method.

In such a manner, the performance degradation parameter analysis method is adopted to effectively evaluate the performance degradation data of the component, and the pre-fault operating duration of the component is obtained. The method can be applied to both the product with performance degradation data and the product with fault data, and accordingly can be applied to a wider range, thereby better satisfying the requirement for rapid evaluation of the reliability weak link of the long-life complex product. Further, the component is evaluated by using the confidence-based unreliability evaluation method, which can evaluate the unreliability at any confidence level, and accordingly can be applied to a wider range. Therefore, the reliability weak link of the complex product can be evaluated by using the selected target component service life distribution model, thereby effectively improving the evaluation accuracy. In addition, the performance degradation-based product reliability weak link evaluation method can also rapidly evaluate the reliability weak link of a high-reliability and long-life complex product.

In some embodiments, a reliability weak link evaluation is performed on a type of to-be-evaluated product. The to-be-evaluated product consists of six components: a control board, a drive board, a power board, a core board, a temperature control board, and a trigger board.

The control board is taken as an example for analysis. The performance degradation parameters of the control board are shown in the following Table 4.

TABLE 4
Performance degradation parameters of the control board

| | | Performance degradation value |
|---|---|---|
| Test serial number | Test time (hours) | (Volt) |
| 1 | 100 | 17.807 |
| 2 | 200 | 17.831 |
| 3 | 300 | 17.932 |
| 4 | 400 | 17.943 |
| 5 | 500 | 17.966 |
| . . . | . . . | . . . |
| 9 | 900 | 18.070 |
| 10 | 1000 | 18.198 |

The performance degradation parameters of the control board are analyzed, and it is obtained that the pre-fault operating duration of the control board is 8875 hours. With the same method, the pre-fault operating durations of 20 out of 50 control boards in the same batch are obtained by means of solution, as shown in the following Table 5.

TABLE 5
Pre-fault operating durations of the control boards

| Serial number of control board | Pre-fault operating duration (hours) |
|---|---|
| 1 | 2710 |
| 2 | 3860 |
| 3 | 4378 |
| 4 | 5983 |
| 5 | 6741 |
| 6 | 7237 |
| 7 | 7602 |
| 8 | 8875 |
| 9 | 9990 |
| 10 | 11008 |
| . . . | . . . |
| 20 | 22322 |

The unreliability evaluation for control boards may be performed without selecting the pre-fault operating durations of all the control boards in the same batch, but by selecting control boards in the same batch with the pre-fault operating durations less than a preset time threshold. Alternatively, the pre-fault operating durations of all control boards in the same batch are sorted from smallest to largest, and the control boards in previous preset positions are selected to perform the unreliability evaluation. As shown in Table 5, the pre-fault operating durations of 20 out of 50 control boards in the same batch are selected. The selected control boards have shorter pre-fault operating durations and worse performances in the same batch.

Consequently, the control boards are evaluated by the confidence-based unreliability evaluation method, and the result of the reliability evaluation is shown in the following Table 6.

TABLE 6
Unreliabilities of the control boards

| Serial number of | Pre-fault operating | |
|---|---|---|
| control board | duration (hours) | Unreliability |
| 1 | 2710 | 0.014 |
| 2 | 3860 | 0.034 |
| 3 | 4378 | 0.054 |
| 4 | 5983 | 0.073 |
| 5 | 6741 | 0.093 |
| 6 | 7237 | 0.113 |
| 7 | 7602 | 0.133 |
| 8 | 8875 | 0.153 |
| 9 | 9990 | 0.173 |
| 10 | 11008 | 0.192 |
| . . . | . . . | . . . |
| 20 | 22322 | 0.391 |

For the control boards, the parameter evaluation and optimization are performed on the cumulative fault probability functions, and finally the cumulative fault probability function 2 is determined as the target cumulative fault probability function of the control boards:

$$F ( t ) = 1 - exp [ - 2.75 \times {10}^{- 5} \times ( t - 2548 ) ] .$$

Accordingly, the mean time between failures T of the control boards is obtained as:

$$T = 38911 h .$$

Similarly, the mean time between failures of each component of the product is obtained as shown in the following Table 7.

TABLE 7
mean time between failures corresponding
to each component of the product

| | | Mean time between |
|---|---|---|
| Serial number | Component | failures (hours) |
| 1 | Control board | 38911 |
| 2 | Drive board | 39548 |
| 3 | Power board | 58835 |
| 4 | Core board | 73931 |
| 5 | Temperature control board | 53542 |
| 6 | Trigger board | 49569 |

The mean time between failures of the components of the product is sorted from smallest to largest in the following corresponding order: control board, drive board, trigger board, temperature control board, power board, and core board. Accordingly, the reliability weak link of the product is the control board and the drive board.

The reliability weak link of the product revealed during the use of the product is the control board and the drive board, which verifies the accuracy and practicality of the solution.

It should be appreciated that, although steps in the flow charts related to the above-mentioned embodiments are sequentially displayed in an order indicated by the arrows, these steps are not definitely sequentially performed in the order indicated by the arrows. Unless expressly stated in this specification, these steps are not performed in a strict order, and these steps may be performed in another order. In addition, at least a part of the steps in the flow charts involved in the above-mentioned embodiments may include multiple steps or multiple phases. These steps or phases are not definitely performed at the same moment, but may be performed at different moments. These steps or phases are not definitely performed sequentially, but may be performed in turns or alternately with at least a part of other steps or steps or phases in another steps.

Based on a same inventive concept, in an embodiment of the present disclosure, a performance degradation-based product reliability weak link evaluation apparatus is provided, which can be applied to implement the above-mentioned performance degradation-based product reliability weak link evaluation method. An implementation solution provided by the apparatus is similar to the implementation solution described in the aforementioned method. Therefore, for specific limitations in the following provided one or more embodiments of the performance degradation-based product reliability weak link evaluation apparatus, reference can be made to the limitations in the aforementioned embodiments of the performance degradation-based product reliability weak link evaluation method, which will not be repeated herein.

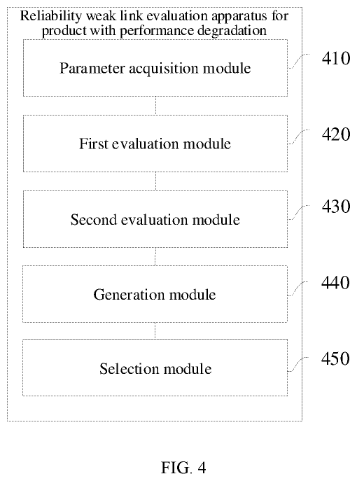

In an embodiment, as shown in FIG. 4, a performance degradation-based product reliability weak link evaluation apparatus is provided, including a parameter acquisition module 410, a first evaluation module 420, a second evaluation module 430, a generation module 440, and a selection module 450.

The parameter acquisition module 410 is configured to acquire a performance degradation parameter of each component of a to-be-evaluated product corresponding to each test time point.

The first evaluation module 420 is configured to evaluate the performance degradation parameter of each component corresponding to each test time point through a fault time evaluation model, to obtain a pre-fault operating duration of each component.

The second evaluation module 430 is configured to evaluate the pre-fault operating duration of each component through a confidence-based unreliability evaluation method, to obtain an unreliability evaluation result of each component.

The generation module 440 is configured to generate at least one component service life distribution model corresponding to each component according to the unreliability evaluation result of each component, and select a corresponding target component service life distribution model.

The selection module 450 is configured to evaluate mean time between failures corresponding to each component according to the target component service life distribution model of each component, and select a reliability weak link of the to-be-evaluated product according to the mean time between failures corresponding to each component.

In an embodiment, the test time points are equally spaced. The first evaluation module 420 is specifically configured to: input the performance degradation parameter of each component corresponding to each test time point into a first transformation unit of the fault time evaluation model, to obtain a performance degradation transformation parameter corresponding to each test time point; input the performance degradation transformation parameter corresponding to each test time point into a second transformation unit of the fault time evaluation model, to obtain a degradation transformation average parameter corresponding to test time points; input the performance degradation parameter and the degradation transformation average parameter into an intermediate parameter determination unit of the fault time evaluation model, to obtain a target intermediate parameter; input the target intermediate parameter into a fault time output unit of the fault time evaluation model to obtain the pre-fault operating duration corresponding to each component.

In an embodiment, the first evaluation module 420 is specifically configured to: determine, through the first transformation unit, a sum of the performance degradation parameters corresponding to a test time point and performance degradation parameters corresponding to each test time point before the test time point as the performance degradation transformation parameter corresponding to the test time point.

In an embodiment, the first evaluation module 420 is specifically configured to: for the performance degradation transformation parameters corresponding to each test time point, determine an average value of performance degradation transformation parameters corresponding to every two adjacent test time points through the second transformation unit, and obtain the degradation transformation average parameter according to the average value of the performance degradation transformation parameters corresponding to every two adjacent test time points.

In an embodiment, there may exist a plurality of same components. A pre-fault operating duration corresponding to the plurality of the same components may include a pre-fault operating duration corresponding to each of the same components. The unreliability evaluation result may include an unreliability corresponding to each pre-fault operating duration. The generation module 440 is specifically configured to: perform fitting on each preset cumulative fault probability function based on the pre-fault operating duration corresponding to each component and the unreliability corresponding to each pre-fault operating duration, to determine a parameter value corresponding to an unknown parameter in each cumulative fault probability function; and generate at least one component service life distribution model corresponding to each component according to the parameter value corresponding to the unknown parameter in each cumulative fault probability function.

In an embodiment, the generation module 440 is specifically configured to: determine a decision function corresponding to each cumulative fault probability function, in which the decision function is built according to a derivative of each cumulative fault probability function, and a function value of each cumulative fault probability function matches the unreliability corresponding to each pre-fault operating duration; and determine the parameter value corresponding to the unknown parameter in each cumulative fault probability function according to the derivative of the corresponding decision function with respect to the unknown parameter in each cumulative fault probability function.

In an embodiment, the selection module 450 is specifically configured to determine a function value of the decision function corresponding to each cumulative fault probability function according to the parameter value corresponding to the unknown parameter in each cumulative fault probability function; determine a cumulative fault probability function corresponding to the maximum value of the decision function as a target cumulative fault probability function; and determine a model represented by the target cumulative fault probability function as the target component service life distribution model.

All modules in the above-mentioned performance degradation-based product reliability weak link evaluation apparatus may be implemented in whole or in part by using software, hardware, and a combination thereof. The above-mentioned modules may be embedded in or independent of a processor of a computer device in a hardware form, or may be stored in a memory in the computer device in a software form, so that the processor invokes to execute operations corresponding to the above-mentioned modules.

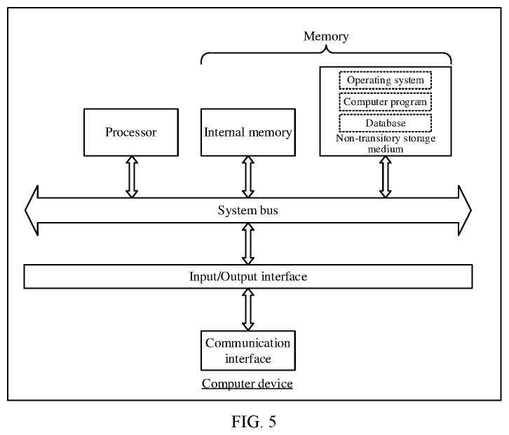

In an embodiment, a computer device is provided. The computer device may be a server, and an internal structure diagram of the computer device may be as shown in FIG. 5. The computer device may include a processor, a memory, an Input/Output (I/O for short) interface, and a communications interface. The processor, the memory, and the input/output interface are connected to each other by the system bus, and the communications interface is connected to the system bus through the input/output interface. The processor of the computer device is configured to provide computing and control capabilities. The memory of the computer device may include a non-transitory storage medium and an internal memory. The non-transitory storage medium stores an operating system, a computer program, and a database. The internal memory provides an environment for running the operating system and the computer program in a non-transitory storage medium. The database of the computer device is configured to store a performance degradation parameter and data of a preset cumulative fault probability function. The input/output interface of the computer device is configured to exchange information between the processor and an external device. The communication interface of the computer device is configured to communicate with an external terminal by using a network connection. The computer program is executed by a processor to implement a performance degradation-based product reliability weak link evaluation method.

Those skilled in the art may understand that the structure shown in FIG. 5 is merely a block diagram of a partial structure related to the solution of the present disclosure, and does not constitute a limitation on a computer device to which the solution of the present disclosure is applied. A specific computer device may include more or fewer components than those shown in the figure, or combine some components, or have different component arrangements.

In an embodiment, a computer device is further provided, including a processor and a memory storing a computer program. The processor, when executing the computer program, implements the steps in the above-mentioned method embodiments.

In an embodiment, a computer readable storage medium is provided, on which a computer program is stored. The computer program, when executed by a processor, may cause the processor to implement the steps in the above-mentioned method embodiments.

In an embodiment, a computer program product is provided, including a computer program. The computer program, when executed by a processor, may cause the processor to implement the steps in the above-mentioned method embodiments.

It should be noted that the user information (including but not limited to the user equipment information, the user personal information, and the like) and the data (including but not limited to the data used for analysis, the stored data, and the displayed data) involved in the present disclosure are authorized by the user or are fully authorized by each party, and related data needs to be collected, used, and processed in compliance with relevant national laws and standards.

Those skilled in the art may understand that all or a part of the processes in the methods in the above-mentioned embodiments may be implemented by a computer program instructing related hardware. The computer program may be stored in a non-transitory computer readable storage medium. When the computer program is executed, the processes in the above-mentioned method embodiments may be included. Any reference to a memory, a database, or other media used in the embodiments provided in the present disclosure may include at least one of a non-transitory memory or a transitory memory. The non-transitory memory may include a Read-Only Memory (ROM), a magnetic tape, a floppy disk, a flash memory, an optical memory, a high-density embedded non-volatile memory, a resistive random access memory (ReRAM), a Magnetoresistive Random Access Memory (MRAM), a Ferroelectric Random Access Memory (FRAM), a Phase Change Memory (PCM), a graphene memory, and the like. The transitory memory may include a Random Access Memory (RAM), an external cache, or the like. As an illustration and not a limitation, the RAM may be in multiple forms, such as a Static Random Access Memory (SRAM) or a Dynamic Random Access Memory (DRAM). The database involved in the embodiments provided in the present disclosure may include at least one of a relational database or a non-relational database. The non-relational database may include a block chain based distributed database or the like, which is not limited thereto. The processor in the embodiments provided in the present disclosure may be a general purpose processor, a central processing unit, a graphics processor, a digital signal processor, a programmable logic device, a quantum computing-based data processing logic device, or the like, which is not limited thereto.

The technical features in the above-mentioned embodiments may be combined in any manner. In order to simplify the description, all possible combinations of the technical features in the above-mentioned embodiments are not described. However, as long as there is no contradiction in the combinations of the technical features, these combinations all should be considered as the scope of the present disclosure.

The aforementioned embodiments represent only several implementation modes of the present disclosure, and the description thereof is more specific and detailed, but may not be construed as limitations on the scope of the present disclosure. It should be noted that those skilled in the art can make some transformations and improvements without departing from the concept of the present disclosure, which all fall within the protection scope of the present disclosure. Therefore, the protection scope of the present disclosure shall be subject to the appended claims.

1. A performance degradation-based product reliability weak link evaluation method, applied to a to-be-evaluated product comprising a plurality of components, at least one of the components having performance degradation data or fault data, the method comprising:
acquiring a performance degradation parameter of each component of the to-be-evaluated product corresponding to each test time point;
evaluating the performance degradation parameter of each component corresponding to each test time point by a fault time evaluation model, to obtain a pre-fault operating duration of each component, which comprising:
inputting the performance degradation parameter of each component corresponding to each test time point into a first transformation unit of a fault time evaluation model to obtain performance degradation transformation parameters corresponding to each test time point, inputting the performance degradation transformation parameters corresponding to each test time point into a second transformation unit of the fault time evaluation model to obtain degradation transformation average parameters corresponding to test time points, inputting the performance degradation parameters and the degradation transformation average parameters into an intermediate parameter determination unit of the fault time evaluation model to obtain target intermediate parameters, inputting the target intermediate parameters into a fault time output unit of the fault time evaluation model to obtain the pre-fault operating duration corresponding to each component,
wherein the performance degradation transformation parameters corresponding to each test time point are determined by the first transformation unit through formulas as follows:
$$\{ \begin{matrix}{y}_{21} = {y}_{11} \\ {y}_{22} = {y}_{11} + {y}_{12} \\ {y}_{23} = {y}_{11} + {y}_{12} + {y}_{13} \\ … \\ {y}_{2 m} = {y}_{11} + {y}_{12} + {y}_{13} + ⋯ + {y}_{1 m} \\ … \\ {y}_{2 d} = {y}_{11} + {y}_{12} + ⋯ + {y}_{1 m} + ⋯ + {y}_{1 d}\end{matrix} ,$$
where d denotes the number of tests corresponding to the test time points,
y₁₁, y₁₂, y₁ₘ, . . . , y_{1d} denote performance degradation parameters of the component at each test time point, and
y₂₁, y₂₂, y₂ₘ, . . . , y_{2d} denote the performance degradation transformation parameters corresponding to each test time point,
wherein the degradation transformation average parameters are determined by the second transformation unit through formulas as follows:
$$\{ \begin{matrix}{y}_{32} = ( {y}_{21} + {y}_{22} ) / 2 \\ {y}_{33} = ( {y}_{22} + {y}_{23} ) / 2 \\ {y}_{34} = ( {y}_{23} + {y}_{24} ) / 2 \\ … \\ {y}_{3 m} = ( {y}_{2 m - 1} + {y}_{2 m} ) / 2 \\ … \\ {y}_{3 d} = ( {y}_{2 d - 1} + {y}_{2 d} ) / 2\end{matrix}$$
where y₃₂, y₃₃, y₃ₘ, . . . , y_{3d} denote the degradation transformation average parameters corresponding to the test time points,
wherein the target intermediate parameters are determined by the intermediate parameter determination unit through a formula as follows:
$$( \begin{matrix}e \\ f\end{matrix} ) = {( \begin{matrix}{y}_{32}^{2} + {y}_{33}^{2} + ⋯ + {y}_{3 d}^{2} & {y}_{32} + {y}_{33} + ⋯ + {y}_{3 d} \\ {y}_{32} + {y}_{33} + ⋯ + {y}_{3 d} & d - 1\end{matrix} )}^{- 1} \times ( \begin{matrix}{y}_{12} {y}_{32} + {y}_{12} {y}_{33} + ⋯ + {y}_{1 d} {y}_{3 d} \\ {y}_{12} + {y}_{13} + ⋯ + {y}_{1 d}\end{matrix} )$$
where e and f denote the target intermediate parameters,
wherein the pre-fault operating duration t corresponding to each component is determined by the fault time output unit through a formula as follows:
$$t = Δ t \times [ 1 - \frac{1}{e} ln ( \frac{eW - f}{{ey}_{11} - f} ) ] ,$$
where Δt denotes a time interval between test time points, and W denotes a performance degradation fault threshold corresponding to each component;
evaluating the pre-fault operating duration of each component through a confidence-based unreliability evaluation method, to obtain an unreliability evaluation result of each component;
generating at least one component service life distribution model corresponding to each component according to the unreliability evaluation result of each component, and selecting a corresponding target component service life distribution model; and
evaluating mean time between failures corresponding to each component according to the target component service life distribution model of each component, and selecting a reliability weak link of the to-be-evaluated product according to the mean time between failures corresponding to each component.

2. The method according to claim 1, wherein the inputting the performance degradation parameters of each component corresponding to each test time point into the first transformation unit of the fault time evaluation model to obtain the performance degradation transformation parameters corresponding to each test time point comprises:
determining, by the first transformation unit, a sum of performance degradation parameters corresponding to a test time point and performance degradation parameters corresponding to each test time point before the test time point as a performance degradation transformation parameter corresponding to the test time point.

3. The method according to claim 1, wherein the inputting the performance degradation transformation parameters corresponding to each test time point into the second transformation unit of the fault time evaluation model to obtain the degradation transformation average parameters corresponding to test time points comprises:
for the performance degradation transformation parameters corresponding to each test time point, determining an average value of performance degradation transformation parameters corresponding to every two adjacent test time points by the second transformation unit; and
obtaining a degradation transformation average parameter according to an average value of the performance degradation transformation parameters corresponding to every two adjacent test time points.

4. The method according to claim 1, wherein there exists a plurality of same components, a pre-fault operating duration corresponding to the plurality of same components comprises a pre-fault operating duration corresponding to each of the same components, and the unreliability evaluation result comprises an unreliability corresponding to each pre-fault operating duration,
wherein the generating at least one component service life distribution model corresponding to each component according to the unreliability evaluation result of each component comprises:
performing fitting on each preset cumulative fault probability function based on the pre-fault operating duration corresponding to each component and the unreliability corresponding to each pre-fault operating duration, to determine a parameter value corresponding to an unknown parameter in each cumulative fault probability function; and
generating at least one component service life distribution model corresponding to each component according to the parameter value corresponding to the unknown parameter in each cumulative fault probability function.

5. The method according to claim 4, wherein the performing the fitting on each preset cumulative fault probability function based on the pre-fault operating duration corresponding to each component and the unreliability corresponding to each pre-fault operating duration to determine the parameter value corresponding to the unknown parameter in each cumulative fault probability function comprises:
determining a decision function corresponding to each cumulative fault probability function, wherein the decision function is built according to a derivative of each cumulative fault probability function, and a function value of each cumulative fault probability function matches the unreliability corresponding to each pre-fault operating duration; and
determining the parameter value corresponding to the unknown parameter in each cumulative fault probability function according to the derivative of the corresponding decision function with respect to the unknown parameter in each cumulative fault probability function.

6. The method according to claim 5, wherein the selecting the corresponding target component service life distribution model comprises:
determining a function value of the decision function corresponding to each cumulative fault probability function according to the parameter value corresponding to the unknown parameter in each cumulative fault probability function; and
determining a cumulative fault probability function corresponding to the maximum value of the decision function as a target cumulative fault probability function, and determining a model represented by the target cumulative fault probability function as the target component service life distribution model.

7. A performance degradation-based product reliability weak link evaluation apparatus, applied to a to-be-evaluated product comprising a plurality of components, at least one of the components having performance degradation data or fault data, the apparatus comprising:
a parameter acquisition module, configured to acquire a performance degradation parameter of each component of the to-be-evaluated product corresponding to each test time point;
a first evaluation module, configured to evaluate the performance degradation parameter of each component corresponding to each test time point through a fault time evaluation model, to obtain a pre-fault operating duration of each component;
wherein the first evaluation module is specifically configured to input the performance degradation parameters of each component corresponding to each test time point into a first transformation unit of a fault time evaluation model to obtain performance degradation transformation parameters corresponding to each test time point, input the performance degradation transformation parameters corresponding to each test time point into a second transformation unit of the fault time evaluation model to obtain degradation transformation average parameters corresponding to test time points, input the performance degradation parameters and the degradation transformation average parameters into an intermediate parameter determination unit of the fault time evaluation model to obtain target intermediate parameters, input the target intermediate parameters into a fault time output unit of the fault time evaluation model to obtain the pre-fault operating duration corresponding to each component,
wherein the performance degradation transformation parameters corresponding to each test time point are determined by the first transformation unit through formulas as follows:
$$\{ \begin{matrix}{y}_{21} = {y}_{11} \\ {y}_{22} = {y}_{11} + {y}_{12} \\ {y}_{23} = {y}_{11} + {y}_{12} + {y}_{13} \\ … \\ {y}_{2 m} = {y}_{11} + {y}_{12} + {y}_{13} + ⋯ + {y}_{1 m} \\ … \\ {y}_{2 d} = {y}_{11} + {y}_{12} + ⋯ + {y}_{1 m} + ⋯ + {y}_{1 d}\end{matrix} ,$$
where d denotes the number of tests corresponding to the test time points,
y₁₁, y₁₂, y₁ₘ, . . . , y_{1d} denote performance degradation parameters of the component at each test time point,
y₂₁, y₂₂, y₂ₘ, . . . , y_{2d} denote the performance degradation transformation parameters corresponding to each test time point,
wherein the degradation transformation average parameters are determined by the second transformation unit through formulas as follows:
$$\{ \begin{matrix}{y}_{32} = ( {y}_{21} + {y}_{22} ) / 2 \\ {y}_{33} = ( {y}_{22} + {y}_{23} ) / 2 \\ {y}_{34} = ( {y}_{23} + {y}_{24} ) / 2 \\ … \\ {y}_{3 m} = ( {y}_{2 m - 1} + {y}_{2 m} ) / 2 \\ … \\ {y}_{3 d} = ( {y}_{2 d - 1} + {y}_{2 d} ) / 2\end{matrix} ,$$
where y₃₂, y₃₃, y₃ₘ, . . . , y_{3d} denote the degradation transformation average parameters corresponding to the test time points,
wherein the target intermediate parameters are determined by the intermediate parameter determination unit through a formula as follows:
$$( \begin{matrix}e \\ f\end{matrix} ) = {( \begin{matrix}{y}_{32}^{2} + {y}_{33}^{2} + ⋯ + {y}_{3 d}^{2} & {y}_{32} + {y}_{33} + ⋯ + {y}_{3 d} \\ {y}_{32} + {y}_{33} + ⋯ + {y}_{3 d} & d - 1\end{matrix} )}^{- 1} \times ( \begin{matrix}{y}_{12} {y}_{32} + {y}_{13} {y}_{33} + ⋯ + {y}_{1 d} {y}_{3 d} \\ {y}_{12} + {y}_{13} + ⋯ + {y}_{1 d}\end{matrix} ) ,$$
where e and f denote the target intermediate parameters;
wherein the pre-fault operating duration t corresponding to each component is determined by the fault time output unit through a formula as follows:
$$t = Δ t \times [ 1 - \frac{1}{e} ln ( \frac{eW - f}{{ey}_{11} - f} ) ] ,$$
where Δt denotes a time interval between test time points, and W denotes a performance degradation fault threshold corresponding to each component;
a second evaluation module, configured to evaluate the pre-fault operating duration of each component through a confidence-based unreliability evaluation method, to obtain an unreliability evaluation result of each component;
a generation module, configured to generate at least one component service life distribution model corresponding to each component according to the unreliability evaluation result of each component, and select a corresponding target component service life distribution model; and
a selection module, configured to evaluate mean time between failures corresponding to each component according to the target component service life distribution model of each component, and select a reliability weak link of the to-be-evaluated product according to the mean time between failures corresponding to each component.

8. The apparatus according to claim 7, wherein there exists a plurality of same components, a pre-fault operating duration corresponding to the plurality of same components comprises a pre-fault operating duration corresponding to each of the same components, the unreliability evaluation result comprises an unreliability corresponding to each pre-fault operating duration,
wherein the generation module is further configured to perform fitting on each preset cumulative fault probability function based on the pre-fault operating duration corresponding to each component and the unreliability corresponding to each pre-fault operating duration to determine a parameter value corresponding to an unknown parameter in each cumulative fault probability function, and generate at least one component service life distribution model corresponding to each component according to the parameter value corresponding to the unknown parameter in each cumulative fault probability function.

9. A computer device, comprising a processor and a memory storing a computer program, wherein the processor, when executing the computer program, implements the step of the method according to claim 1.

10. A non-transitory computer-readable storage medium, on which a computer program is stored, wherein the computer program, when executed by a processor, causes the processor to implement the steps of the method according to claim 1.

11. The method according to claim 1, wherein the to-be-evaluated product comprises a control board, a drive board, a power board, a core board, a temperature control board, and a trigger board.
